(19) United States
(12) Patent Application Publication
(10) Pub. No.: US 2009/0176126 A1
(43) Pub. Date: Jul. 9, 2009

(54) Magnesium metal product with reinforcing structure

(75) Inventors: Y. H. Kao, Tainan (TW); Emily Hsiao, Tainan (TW)

Correspondence Address: BACON & THOMAS, PLLC, 625 SLATERS LANE, FOURTH FLOOR, ALEXANDRIA, VA, 22314-1176, US

(73) Assignee: JIING TUNG TEC. METAL CO., LTD., Tainan (TW)

(21) Appl. No.: 12/007,295

(22) Filed: Jan. 9, 2008

(51) Int. Cl. B32B 15/01

(52) U.S. Cl. 428/649

(57) ABSTRACT

A magnesium metal product with reinforcing structure includes a magnesium metal product manufactured by forging a magnesium alloy, and one or more layers of a reinforcing metal provided on the magnesium metal product at predetermined positions to increase the structural strength of the magnesium metal product. The magnesium metal product may be differently shaped for making metal loop, telescopic tube, L-shaped or U-shaped handle, etc. The reinforcing metal may be a short steel bar, or a straight or a bent steel sleeve for associating with inner or outer side of the magnesium metal product. The steel sleeve associated with the outer side of the magnesium metal product may be provided with openings or recesses for receiving the magnesium alloy therein to thereby create increased bonding strength and provide an anti-slip device, ornaments, or a logo.

### FIELD OF THE INVENTION

The present invention relates to a magnesium metal product with reinforcing structure, and more particularly to a magnesium metal product manufactured by forging a magnesium alloy and locally reinforced by one or more layers of a reinforcing metal to obtain increased structural strength to resist external stress and breaking.

### BACKGROUND OF THE INVENTION

Aluminum is stable in air and may have excellent finish through anodic process, and therefore has become one of the metals most widely applied in the world during past fifty years. Aluminum has been applied in construction industry, aeronautical industry, container transport industry, mechanical equipment, home appliances, etc. Anything used in daily life requiring the advantages of solid structure, beautiful appearance, light weight, and easy to carry, such as strollers, walking sticks, backpacks, karabiners, etc., all can be manufactured using aluminum alloys.

However, as a matter of fact, aluminum is an element hazardous to human body. Excessive intake of aluminum will endanger people's health. In our daily life, the aluminum taken in by human comes from a variety of sources, including aluminum-containing compounds in running water filters; fruits, vegetables, and foods absorbing aluminum element in acid rain; precipitated aluminum ions from aluminum cooking wares and dinner sets; and aluminum cans that contain aluminum 20 times higher than glass bottles. It has been found by experts in 1970s that exceeded aluminum intake will accumulate in human neural cells to hinder the same from functioning normally. It is also found the aluminum contained in the brain of patients suffering from Alzheimer's disease is 10 to 30 times higher than normal persons. Excessive aluminum in human body also forms a hindrance to the normal metabolism of calcium and phosphorus, and tends to lower the activity of pepsin to cause osteoporosis, disorders in digestion, and early aging. On the contrary, magnesium element, which is also a light metal, is a major composition of bone and a prerequisite mineral to human body. Magnesium not only helps in the absorption of calcium and potassium, but also has the functions of preventing heart disease, diabetes, and nocturia, and lowering cholesterol.

Magnesium is a high-performance lightweight structural material and possesses many advantages as compared with other metal materials. Magnesium has a specific gravity of 1.7, which is only two-third of the aluminum specific gravity of 2.7, and 21% of the steel specific gravity of 7.9, and is obviously a perfect lightweight material. Moreover, magnesium alloys also have high strength to weight ratio, rigidity, impact resistance, and wear-resistance. Magnesium products are completely recoverable and environment-friendly without causing pollution, and have the properties of absorbing electromagnetic wave and vibration. Therefore, magnesium products are largely welcome among 3C (computer, communication, and consumer electronics) industries.

Under the worldwide trends of lightweight and environment protection, magnesium alloys have become the new generation of most important structural materials with excellent potential in different applications. Many industrial fields have tried to replace plastic or aluminum products with magnesium products. Nevertheless, magnesium alloy products have the disadvantages of having higher raw material cost than aluminum, and requiring the pressure-casting and half-molten injection molding techniques to manufacture them. Since magnesium has somewhat poor fluidity, it is highly difficult to form magnesium workpiece with low thickness in the pressure-casting process to thereby increase the bad yield thereof. The magnesium alloy products are subject to heat-checking, oxidation, streaks, warp, and insufficient strength. Since it is uneasy to control the thickness of the finished magnesium products, complicated rear-stage finishing processes, such as burring, puttying, painting, baking, etc., are required. During these finishing processes, toxic substances tend to be blended into the magnesium metal material to cause problems in recovery of magnesium products. Therefore, some of the magnesium metal products fail to meet the environmental protection requirements set by some advanced European and American countries.

To overcome the above-mentioned disadvantages of currently available magnesium metal products, the inventor has conducted many experiments and tests to finally successfully employ the press forging process in the manufacturing of magnesium alloy workpiece. The magnesium material after forging and pressing has a dense and solid quality to allow good molding effect, and is therefore suitable for manufacturing products with complicate structure at shortened manufacturing time and upgraded good yield. The press-forged magnesium alloy has smooth surface to facilitate subsequent machining without the need of burring, puttying, and painting, which are otherwise required in the conventional pressure-casting process.

While it has been proven the advanced press-forging process may be advantageously employed in processing of magnesium alloys, it is also found the products made of only the magnesium alloy, such as magnesium bars or tubes, have insufficient structural strength at areas subject to relatively large external stress, such as telescoped joints on a telescopic tube, bent angles on a handle, etc. That is, these areas on magnesium alloy products have relatively weak resistance to breaking.

Therefore, it is desirable to develop a magnesium metal product that is locally reinforced using one or more layers of a reinforcing metal to thereby largely increase the structural strength of the magnesium metal product, allowing the same to effectively resist external stress without the risk of breaking easily.

### SUMMARY OF THE INVENTION

A primary object of the present invention is to provide a magnesium metal product with reinforcing structure, which includes a magnesium metal product manufactured by forging a magnesium alloy, and one or more layers of a reinforcing metal provided on the magnesium metal product at predetermined positions to increase the structural strength of the magnesium metal product, so that the magnesium metal product may resist external stress and be protected against breaking.

The magnesium metal product may be a solid long bar, a straight tube, or a bent tube for making a solid metal loop, such as a karabiner, a telescopic tube, an L-shaped or U-shaped handle, etc. The reinforcing metal may be a short length of steel bar, a straight steel sleeve, or a bent steel sleeve for associating with an inner or an outer side of the magnesium metal product at open ends or bent portions thereof.

The steel sleeve associated with the outer side of the magnesium metal product may be provided with openings or recesses for receiving the magnesium alloy therein to thereby create increased bonding strength between the magnesium metal product and the reinforcing metal, and serve as an anti-slip device, ornamental patterns, or a logo of the product.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectioned perspective view of a solid bar as a first magnesium metal product with reinforcing structure according to the present invention;

FIG. 2 shows a karabiner made of the magnesium metal product of FIG. 1;

FIG. 3 is a sectioned side view of a straight tube as a second magnesium metal product with reinforcing structure according to the present invention;

FIG. 4 is across sectional view showing the straight tube of FIG. 3 has a reinforcing metal provided to an inner wall surface thereof;

FIG. 5 is across sectional view showing the straight tube of FIG. 3 has a reinforcing metal provided to an outer wall surface thereof;

FIG. 6 is a sectioned side view of a telescopic tube made of the straight tubes of FIGS. 4 and 5;

FIG. 7 is a sectioned side view of a bent tube as a third magnesium metal product with reinforcing structure according to the present invention;

FIG. 8 schematically shows the manner of manufacturing the bent tube of FIG. 7;

FIG. 9 is a plan view of an anti-slip handle made of the bent tube of FIG. 7;

FIG. 10 is a cross sectional view of a tube as a fourth magnesium metal product with reinforcing structure according to the present invention, wherein the reinforcing metal thereof is provided with a plurality of openings; and

FIG. 11 is a plan view of an anti-slip handle made of the tube of FIG. 10.

### DETAILED DESCRIPTION OF THE PREFERRED EMBODIMENTS

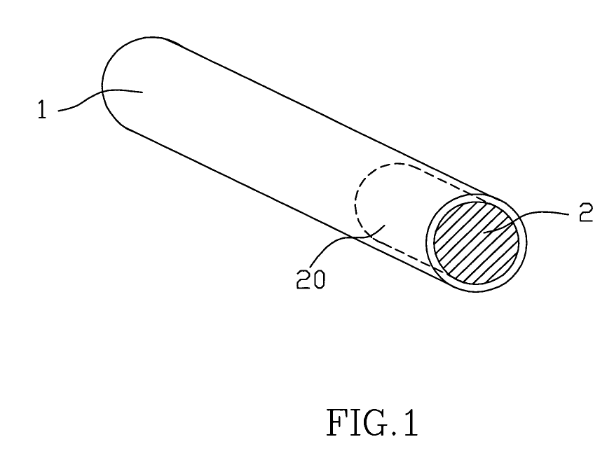

Please refer to FIG. 1. A magnesium metal product with reinforcing structure according to a preferred embodiment of the present invention includes a magnesium metal product 1 manufactured by forging a magnesium alloy and one or more layers of a reinforcing metal 2 provided on the magnesium metal product 1 at predetermined locations thereof.

The magnesium metal product 1 may have different configurations, such as a solid long bar as shown in FIG. 1, a flat plate (not shown), or a block (not shown). The reinforcing metal 2 may be a short length of steel bar 20 or other metal bars with toughness similar to that of steel bar.

The reinforcing metal 2 may be associated with the magnesium metal product 1 by screwing, forging, bonding, etc. When a plurality of layers of the reinforcing metal 2 are provided on the magnesium metal product 1 at locations subject to external forces, the magnesium metal product 1 may have effectively increased structural strength. The multiple layers of reinforcing metal 2 function to resist external stress and protect the magnesium metal product 1 against breaking.

When the reinforcing metal 2 is associated with the magnesium metal product 1 by forging, first soften the magnesium alloy and the multiple layers of reinforcing metal and position them in a mold, so that the softened metal materials are compressed, combined, and molded. When the reinforcing metal 2 having a relatively higher temperature is compressed into the magnesium alloy having a relatively lower temperature, the reinforcing metal 2 will indirectly heat the magnesium alloy through heat exchange to further increase the temperature of the magnesium alloy, ensuring the two metal materials to melt and mix through a eutectic reaction and the mixture thereof has the optimal bonding strength.

The magnesium metal product 1 manufactured by forging a magnesium alloy not only has good molded shape, but also allows the forming of complicated structure, quick production, and effectively increased good yield. The forged magnesium metal product 1 has smooth surface to facilitate subsequent processing and machining.

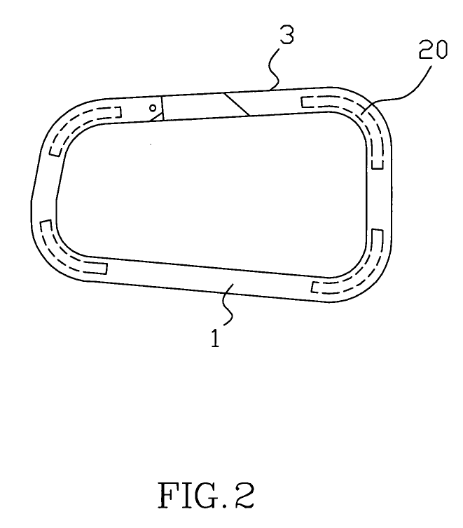

The present invention has a variety of applications. For example, the magnesium metal product 1 in the form of a long solid bar may be used to produce a solid metal loop 3 with multiple bent angles, such as a karabiner shown in FIG. 2, and many other related products, so as to significantly reduce the weight of a mountain climber's equipment. And, a short length of steel bar 20 is embedded in the metal loop 3 at each bent angle thereof, enabling the metal loop 3 to withstand increased load without easily becoming broken.

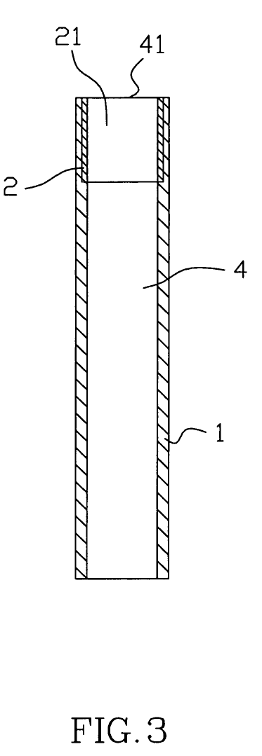

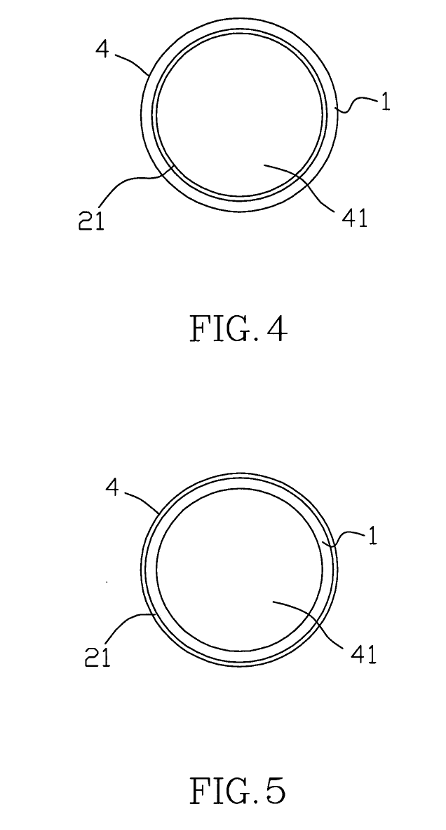

The magnesium metal product 1 may be otherwise a straight round tube 4 as shown in FIG. 3 or a tapered round tube (not shown). In this case, the reinforcing metal 2 may be in the form of a short length of straight steel sleeve 21 being embedded in an inner wall surface of an open end 41 of the magnesium straight round tube 4, as shown in FIGS. 3 and 4, or being fitted on an outer wall surface of the open end 41 of the straight round tube 4, as shown in FIG. 5.

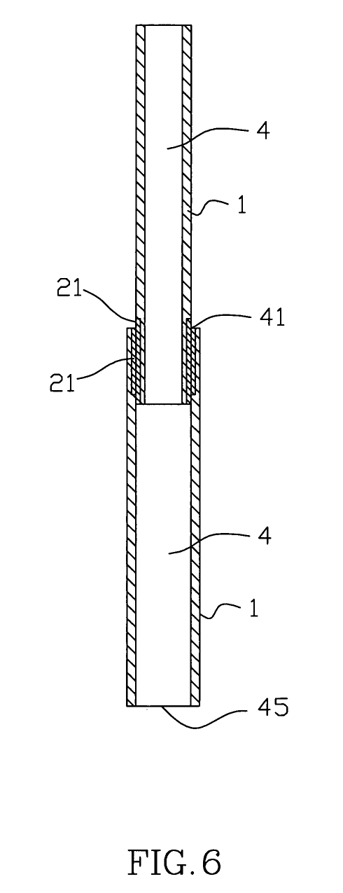

Please refer to FIG. 6. A first straight round tube 4 with the steel sleeve 21 fitted on the outer wall surface of the openend 41 thereof may be slidably fitted in a second straight round tube 4 with the steel sleeve 21 embedded in the inner wall surface of the open end 41 thereof and having an inner diameter larger than an outer diameter of the first tube 4 to provide a telescopic tube 45. Such telescopic tube 45 may be used to manufacture a telescopic walking stick, a telescopic baton, and other similar products. With the straight steel sleeve 21 provided at the two open ends 41 forming a telescoped joint of the telescopic tube 45, the telescoped joint is reinforced to withstand higher external force applied thereto without the risk of bending or breaking, and the telescopic tube 45 is more durable for use.

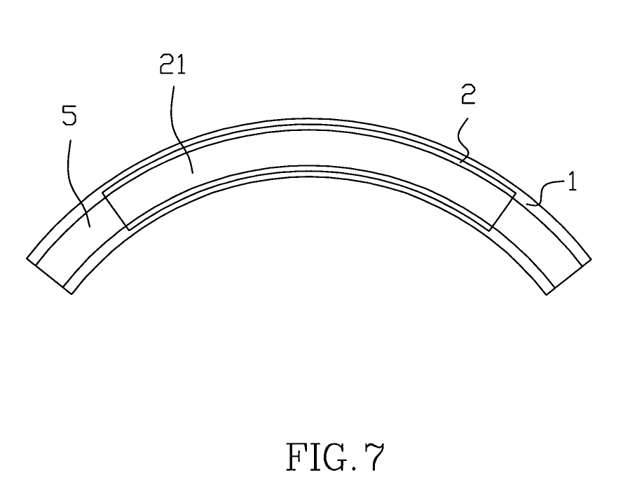

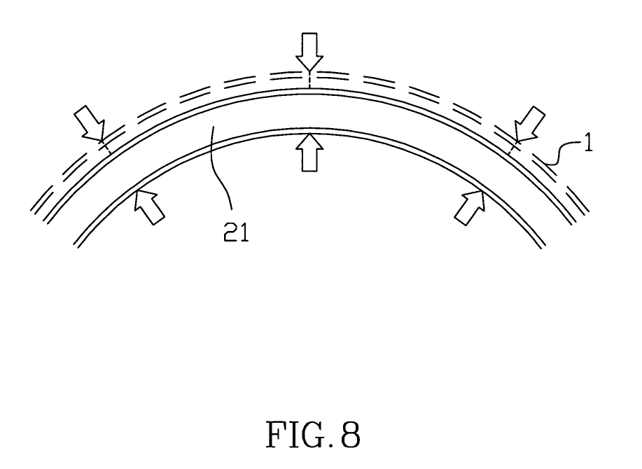

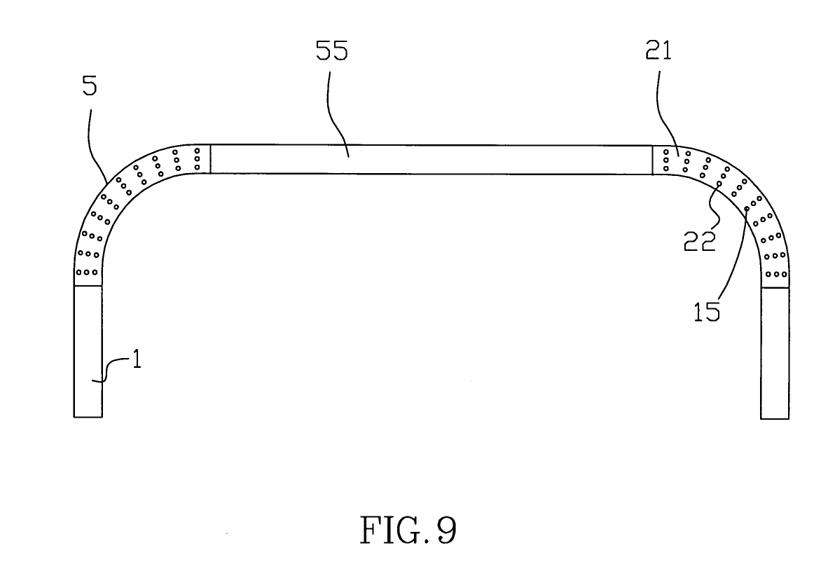

The magnesium metal product 1 may be otherwise a bent tube 5 as shown in FIG. 7. In this case, the reinforcing metal 2 is a bent steel sleeve 21 embedded in an inner wall surface of the bent tube 5 at a bent portion thereof. Alternatively, the bent steel sleeve 21 may be fitted on an outer wall surface of the bent tube 5 at the bent portion thereof (not shown). Please refer to FIG. 8. To manufacture the magnesium bent tube 5 reinforced with the bent steel sleeve 21 as shown in FIG. 7, first fit a straight steel sleeve 21 in a straight magnesium tube having an inner diameter relatively larger than an outer diameter of the steel sleeve, and then position the two tubes in mold for forming the magnesium bent tube 5 reinforced with the bent steel sleeve 21 through a press-forging process. The reinforced magnesium bent tube 5 maybe conveniently used to manufacture an L-shaped handle (not shown), or a U-shaped handle 55 as shown in FIG. 9 for use as a handlebar of a bicycle, a handle for stroller (not shown).

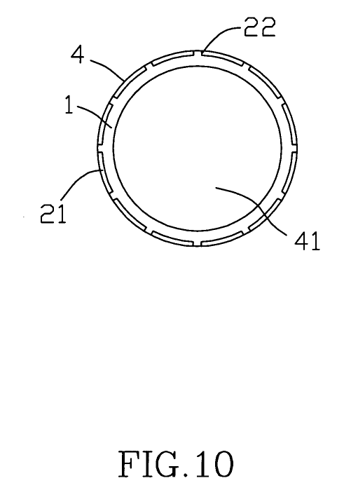

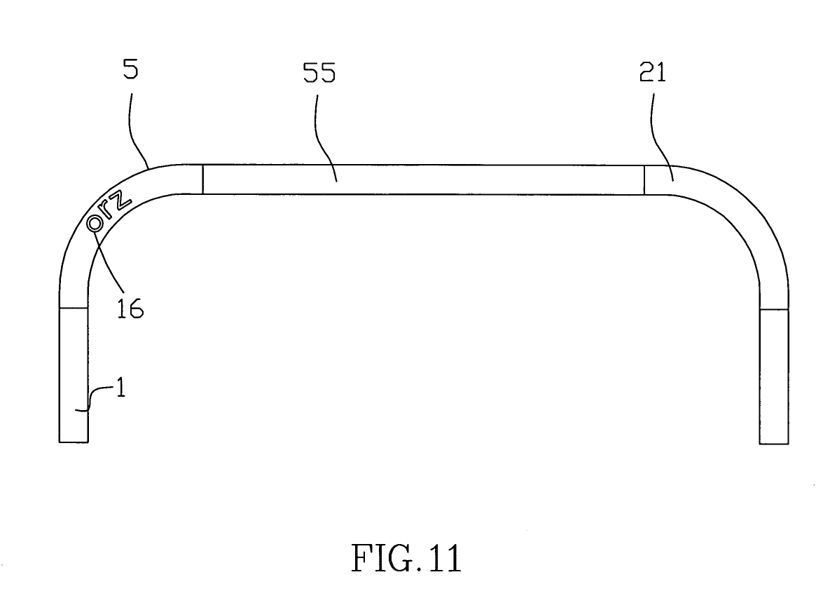

Please refer to FIGS. 9 to 11. To further enhance the bond strength between the magnesium metal product 1 and the reinforcing metal 2, the steel sleeve 21 may be provided on its wall surface with a plurality of openings 22 as shown in FIG. 10 or recesses (not shown), so that the magnesium alloy may be filled in these openings 22 or recesses to form an integral body with the reinforcing metal 2 during the press-forging process to ensure good bonding between them. In the case the steel sleeve 21 is fitted on the outer wall surface of the magnesium straight or bent tube 4, 5, the openings 22 or the recesses filled with the magnesium alloy naturally form different patterns, which may serve as ornaments or anti-slip dots 15 as shown in FIG. 9, or form a logo 16 as shown in FIG. 11. Therefore, the use of the reinforcing metal 2 not only reinforces but also decorates the magnesium metal product 1.

With the above arrangements, the present invention best utilizes the metallurgical and physical properties of magnesium alloys to allow easier forming of a variety of rigid magnesium metal products at largely increased good yield, and the magnesium metal products may be locally reinforced with one or more layers of other metal materials to obtain enhanced structural strength to resist external stress and undesired breaking. The present invention has been described with some preferred embodiments thereof and it is understood that many changes and modifications in the described embodiments can be carried out without departing from the scope and the spirit of the invention that is intended to be limited only by the appended claims.

What is claimed is:

1. A magnesium metal product with reinforcing structure, comprising:
a magnesium metal product manufactured by forging a magnesium alloy; and
one or more layers of a reinforcing metal provided on the magnesium metal product at predetermined locations thereof;
whereby the magnesium metal product may have increased structural strength to resist external stress and breaking.

2. The magnesium metal product with reinforcing structure as claimed in claim 1, wherein the magnesium metal product is in the form of a long solid bar, and the reinforcing metal is a short length of steel bar.

3. The magnesium metal product with reinforcing structure as claimed in claim 2, wherein the magnesium metal product is a solid metal loop with a plurality of bent angles, and the short length of steel bar is curved and embedded in the metal loop at each of the bent angles.

4. The magnesium metal product with reinforcing structure as claimed in claim 1, wherein the magnesium metal product is selected from the group consisting of a straight tube and a tapered tube, and the reinforcing metal is a length of straight steel sleeve; and wherein the straight steel sleeve may be embedded in an inner wall surface of an open end of the magnesium tube, or fitted on an outer wall surface of an open end of the magnesium tube.

5. The magnesium metal product with reinforcing structure as claimed in claim 4, wherein the magnesium metal product is a telescopic tube consisting of a plurality of the reinforced tubes having different diameters adapted to be telescopically assembled together.

6. The magnesium metal product with reinforcing structure as claimed in claim 1, wherein the magnesium metal product is a bent tube, and the reinforcing metal is a bent steel sleeve; and wherein the bent steel sleeve is embedded in an inner wall surface of the bent tube at each bent portion, or fitted on an outer wall surface of the bent tube at each bent portion.

7. The magnesium metal product with reinforcing structure as claimed in claim 6, wherein the magnesium metal product is an L-shaped or a U-shaped handle.

8. The magnesium metal product with reinforcing structure as claimed in claim 4, wherein the steel sleeve is provided on a wall surface with a plurality of openings or recesses for receiving the magnesium alloy therein when the steel sleeve is associated with the magnesium tube, so as to produce a enhanced bonding strength between the magnesium metal product and the reinforcing metal.

9. The magnesium metal product with reinforcing structure as claimed in claim 6, wherein the steel sleeve is provided on a wall surface with a plurality of openings or recesses for receiving the magnesium alloy therein when the steel sleeve is associated with the magnesium tube, so as to produce a enhanced bonding strength between the magnesium metal product and the reinforcing metal.

10. The magnesium metal product with reinforcing structure as claimed in claim 8, wherein the steel sleeve with openings or recesses is fitted on the outer wall surface of the magnesium tube, so that the steel sleeve with the openings or recesses filled with the magnesium alloy functions to reinforce and decorate the magnesium tube at the same time.

11. The magnesium metal product with reinforcing structure as claimed in claim 9, wherein the steel sleeve with openings or recesses is fitted on the outer wall surface of the magnesium tube, so that the steel sleeve with the openings or recesses filled with the magnesium alloy functions to reinforce and decorate the magnesium tube at the same time.

12. The magnesium metal product with reinforcing structure as claimed in claim 1, wherein the magnesium metal product and the reinforcing metal are associated with each other through a manner selected from the group consisting of screwing, forging, and bonding.

13. The magnesium metal product with reinforcing structure as claimed in claim 1, wherein the magnesium metal product is in a form selected from the group consisting of a plate and a block.

14. The magnesium metal product with reinforcing structure as claimed in claim 1, wherein the magnesium metal product and the reinforcing metal are tightly bonded into an integral body through a eutectic reaction.
